(19) United States
(12) Patent Application Publication
(10) Pub. No.: US 2025/0153006 A1
(43) Pub. Date: May 15, 2025

(54) GOLF BALL COVER MATERIAL AND GOLF BALL USING THE SAME

(71) Applicant: Sumitomo Rubber Industries, Ltd., Kobe-shi (JP)

(72) Inventors: Mami TANAKA, Kobe-shi (JP); Toshiyuki TARAO, Kobe-shi (JP)

(73) Assignee: Sumitomo Rubber Industries, Ltd., Kobe-shi (JP)

(21) Appl. No.: 18/941,206

(22) Filed: Nov. 8, 2024

(30) Foreign Application Priority Data
Nov. 10, 2023 (JP) 2023-192231

(51) Int. Cl. A63B 37/00

(52) U.S. Cl. CPC A63B 37/0031

(57) ABSTRACT

An object of the present disclosure is to provide a novel golf ball cover material from which a golf ball showing a high spin rate on short iron shots and a low spin rate on driver shots is obtained. The present disclosure provides a golf ball cover material having a loss elastic modulus (E″₋₄₀) in a range from 6.50×10⁷ Pa to 22.0×10⁷ Pa at a measuring temperature of −40° C., and a loss elastic modulus (E″₋₂₀) in a range from 3.50×10⁷ Pa to 7.10×10⁷ Pa at a measuring temperature of −20° C., when measured using a dynamic viscoelasticity measuring apparatus under following measuring conditions:
<Measuring conditions>
Measuring mode: tensile mode
Measuring temperature: −100° C. to 100° C.
Temperature rising rate: 4° C./minute
Oscillation frequency: 10 Hz
Measuring strain: 0.05%.

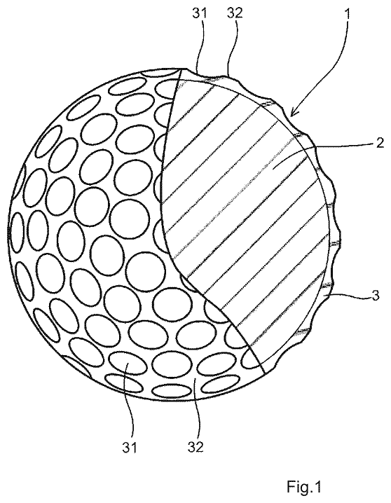

### FIELD OF THE DISCLOSURE

The present disclosure relates to a novel golf ball cover material, and a golf ball using the same.

### DESCRIPTION OF THE RELATED ART

As a resin component constituting a cover of a golf ball, an ionomer resin or a polyurethane is used. The ionomer resin is widely used in view of its excellent resilience, durability and processability. However, the problems have been pointed out that the shot feeling is poor because the cover containing the ionomer resin has high rigidity and hardness and that the controllability is also poor because the spin performance is insufficient. On the other hand, if the polyurethane is used as the resin component constituting the cover, it is known that the shot feeling and spin performance are improved compared with the ionomer resin.

Regarding the spin performance of the golf ball, a high spin rate on approach shots is preferred, but a low spin rate on driver shots is preferred. Therefore, a golf ball material that exerts appropriate spin performance depending on various shots has been studied.

For example, JP 2011-125438 A discloses a golf ball cover material having a shear loss elastic modulus G″ of 1.95×10⁷ Pa or less, and a ratio (E″/G″) of a tensile loss elastic modulus E″ to the shear loss elastic modulus G″ of 1.78 or more, wherein the shear loss elastic modulus G″ is measured in a shear mode and the tensile loss elastic modulus E″ is measured in a tensile mode using a dynamic viscoelasticity measuring apparatus under measuring conditions of an oscillation frequency of 10 Hz and a temperature of 0° C.

In addition, JP 2012-45223 A discloses a golf ball cover material having shear loss elastic moduli G1″ (Pa), G2″ (Pa) and G3″ (Pa) that satisfy log G1″≤7.09, log G2″≥7.17 and log G3″≤7.14 when measured using a dynamic viscoelasticity measuring apparatus under specific measuring conditions.

### SUMMARY OF THE DISCLOSURE

An object of the present disclosure is to provide a novel golf ball cover material for a golf ball showing a high spin rate on short iron shots and a low spin rate on driver shots.

The present disclosure that has solved the above problem provides a golf ball cover material having a loss elastic modulus (E″₋₄₀) in a range from 6.50×10⁷ Pa to 22.0×10⁷ Pa at a measuring temperature of −40° C., and a loss elastic modulus (E″₋₂₀) in a range from 3.50×10⁷ Pa to 7.10×10⁷ Pa at a measuring temperature of −20° C., when measured using a dynamic viscoelasticity measuring apparatus under following measuring conditions:
<Measuring conditions>
Measuring mode: tensile mode
Measuring temperature: −100° C. to 100° C.
Temperature rising rate: 4° C./minute
Oscillation frequency: 10 Hz
Measuring strain: 0.05%.

If the golf ball cover material according to the present disclosure is used, the spin rate on short iron shots increases, and the spin rate on driver shots decreases.

### BRIEF DESCRIPTION OF THE DRAWINGS

The FIGURE is a partially cutaway cross-sectional view showing a golf ball according to one embodiment of the present disclosure.

### DESCRIPTION OF THE PREFERRED EMBODIMENT

### [Golf Ball Cover Material]

The present disclosure provides a golf ball cover material having a loss elastic modulus (E″₋₄₀) in a range from 6.50×10⁷ Pa to 22.0×10⁷ Pa at a measuring temperature of −40° C., and a loss elastic modulus (E″₋₂₀) in a range from 3.50×10⁷ Pa to 7.10×10⁷ Pa at a measuring temperature of −20° C., when measured using a dynamic viscoelasticity measuring apparatus under following measuring conditions:
<Measuring conditions>
Measuring mode: tensile mode
Measuring temperature: −100° C. to 100° C.
Temperature rising rate: 4° C./minute
Oscillation frequency: 10 Hz
Measuring strain: 0.05%.

The loss elastic modulus (E″₋₄₀) at the measuring temperature of −40° C. is a property affecting the spin rate on driver shots. The spin rate on driver shots can be decreased by controlling the loss elastic modulus (E″₋₄₀).

The loss elastic modulus (E″₋₄₀) is preferably 6.50×10⁷ Pa or more, more preferably 6.60×10⁷ Pa or more, and even more preferably 6.70×10⁷ Pa or more, and is preferably 22.0×10⁷ Pa or less, more preferably 21.0×10⁷ Pa or less, and even more preferably 20.0×10⁷ Pa or less.

If the loss elastic modulus (E″₋₄₀) is 6.50×10⁷ Pa or more, the spin rate on driver shots decreases, and if the loss elastic modulus (E″₋₄₀) is 22.0×10⁷ Pa or less, the handling in the production process is easier.

The loss elastic modulus (E″₋₂₀) at the measuring temperature of −20° C. is a property affecting the spin rate on short iron shots. The spin rate on short iron shots can be increased by controlling the loss elastic modulus (E″₋₂₀).

The loss elastic modulus (E″₋₂₀) is preferably 3.50×10⁷ Pa or more, more preferably 3.60×10⁷ Pa or more, and even more preferably 3.70×10⁷ Pa or more, and is preferably 7.10×10⁷ Pa or less, more preferably 7.00×10⁷ Pa or less, and even more preferably 6.90×10⁷ Pa or less.

If the loss elastic modulus (E″₋₂₀) is 3.50×10⁷ Pa or more, the spin rate on iron shots increases, and if the loss elastic modulus (E″₋₂₀) is 7.10×10⁷ Pa or less, lowering in the ball initial velocity on driver shots is controlled.

The slab hardness of the golf ball cover material is preferably 65 or more, more preferably 68 or more, and even more preferably 70 or more, and is preferably 95 or less, more preferably 93 or less, and even more preferably 92 or less in Shore A hardness. If the slab hardness is 65 or more in Shore A hardness, the handling in the production process is easier, and if the slab hardness is 95 or less in Shore A hardness, the spin rate on approach shots can be kept high.

The golf ball cover material preferably contains, as a resin component, a polyurethane obtained by a reaction between a polyol and a polyisocyanate.

The polyol is a compound having two or more hydroxy groups in a molecule thereof. The polyol may be used solely, or at least two polyols may be used in combination.

As the polyol constituting the polyurethane, a polyol having a number average molecular weight of 200 or more and 6000 or less is preferably used. The polyol having the number average molecular weight of 200 or more and 6000 or less forms a soft segment and imparts softness to the polyurethane.

The number average molecular weight of the polyol constituting the polyurethane is preferably 200 or more, more preferably 300 or more, and even more preferably 1000 or more, and is preferably 6000 or less, more preferably 4000 or less, and even more preferably 3000 or less. If the number average molecular weight is 200 or more and 6000 or less, the shot feeling of the golf ball is enhanced.

As the polyol constituting the polyurethane, at least one polymer polyol selected from the group consisting of a polyether polyol, a condensed polyester polyol, a lactone polyester polyol, a polycarbonate polyol and an acrylic polyol is preferable. The polymer polyol is a polymer obtained by polymerizing a low molecular compound, and has a plurality of hydroxyl groups. The polymer polyol may be derived from petroleum resources or biomass resources.

Examples of the polyether polyol include polyoxyethylene glycol (PEG), polyoxypropylene glycol (PPG), polytrimethylene ether glycol (PO3G), and polytetramethylene ether glycol (PTMG).

Examples of the condensed polyester polyol include polyethylene adipate (PEA), polybutylene adipate (PBA), and polyhexamethylene adipate (PHMA).

Examples of the lactone polyester polyol include poly-s-caprolactone (PCL).

Examples of the polycarbonate polyol include polyhexamethylene carbonate.

The polymer polyol is preferably a polymer diol having two hydroxy groups. Use of the polymer diol provides a linear thermoplastic polyurethane and facilitates the molding of the polyurethane into the constituent member of the golf ball.

As the polyol constituting the polyurethane, the polyether polyol is preferable. Particularly, the amount of the polyether polyol is preferably 50 mass % or more, more preferably 55 mass % or more, and even more preferably 60 mass % or more in 100 mass % of the polyol constituting the polyurethane. If the amount of the polyether polyol is 50 mass % or more, the mechanical strength can be maintained for a long time. When the golf ball cover material contains two or more polyurethanes, the amount of the polyether polyol preferably falls within the above range in 100 mass % of the polyol constituting each of the polyurethanes.

The polyol constituting the polyurethane preferably contains a first polymer polyol and a second polymer polyol having a number average molecular weight greater than the first polymer polyol. If the polyol contains the first polymer polyol and the second polymer polyol, the spin rate on iron shots further increases.

Examples of the embodiment that the polyol constituting the polyurethane contains the first polymer polyol and the second polymer polyol include an embodiment where the polyol constituting one polyurethane contains the first polymer polyol and the second polymer polyol; and an embodiment where a first polyurethane containing the first polymer polyol as the constituent component, and a second polyurethane containing the second polymer polyol as the constituent component are used in combination.

When the polyol constituting the polyurethane contains the first polymer polyol and the second polymer polyol, the difference (Mm2-Mm1) between the number average molecular weight (Mm2) of the second polymer polyol and the number average molecular weight (Mm1) of the first polymer polyol is preferably 50 or more, more preferably 100 or more, and even more preferably 200 or more, and is preferably 1500 or less, more preferably 1200 or less, and even more preferably 1000 or less.

The number average molecular weight (Mm1) of the first polymer polyol is preferably 200 or more, more preferably 500 or more, and even more preferably 800 or more, and is preferably 3000 or less, more preferably 2000 or less, and even more preferably 1500 or less.

The number average molecular weight (Mm2) of the second polymer polyol is preferably 1000 or more, more preferably 1200 or more, and even more preferably 1400 or more, and is preferably 6000 or less, more preferably 4500 or less, and even more preferably 3000 or less.

The polyisocyanate constituting the polyurethane is not particularly limited, as long as the polyisocyanate has two or more isocyanate groups. The polyisocyanate may be used solely, or at least two polyisocyanates may be used in combination.

Examples of the polyisocyanate include an aromatic polyisocyanate, an alicyclic polyisocyanate, and an aliphatic polyisocyanate.

Examples of the aromatic polyisocyanate include 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), and para-phenylene diisocyanate (PPDI)

Examples of the alicyclic polyisocyanate and the aliphatic polyisocyanate include 4,4′-dicyclohexylmethane diisocyanate (H12MDI), hydrogenated xylylenediisocyanate (H6XDI), hexamethylene diisocyanate (HDI), isophorone diisocyanate (IPDI), and norbornene diisocyanate (NBDI).

As the polyisocyanate constituting the polyurethane, the aromatic polyisocyanate is preferably used from the viewpoint of improving the abrasion resistance. If the aromatic polyisocyanate is used, the obtained polyurethane has enhanced mechanical properties, and the obtained cover has excellent abrasion resistance.

In addition, as the polyisocyanate constituting the polyurethane, the non-yellowing polyisocyanate (TMXDI, XDI, HDI, H₆XDI, IPDI, H₁₂MDI, NBDI, etc.) is preferably used, and 4,4′-dicyclohexylmethane diisocyanate (H₁₂MDI) is more preferably used, from the viewpoint of improving the weather resistance. The 4,4′-dicyclohexylmethane diisocyanate (H₁₂MDI) has a rigid structure, thus the obtained polyurethane has enhanced mechanical properties, and the obtained cover has excellent abrasion resistance.

The polyurethane may further have a chain extender as a constituent component, as long as the chain extender does not impair the effect of the preset disclosure. As the chain extender component, a low molecular weight polyol, a low molecular weight polyamine, or the like can be used.

Examples of the low molecular weight polyol include a diol such as ethylene glycol, diethylene glycol, triethylene glycol, propane diol (e.g. 1,2-propane diol, 1,3-propane diol, 2-methyl-1,3-propane diol), dipropylene glycol, butane diol (e.g. 1,2-butane diol, 1,3-butane diol, 1,4-butane diol, 2,3-butane diol, 2,3-dimethyl-2,3-butane diol), neopentyl glycol, pentane diol, hexane diol, heptane diol, octane diol, and 1,4-cyclohexane dimethylol; a triol such as glycerin, trimethylolpropane, and hexane triol; and a tetraol or hexaol such as pentaerythritol, and sorbitol.

In addition, the low molecular weight polyamine that can be used as the chain extender component is not particularly limited, as long as it has at least two amino groups.

Examples of the polyamine include an aliphatic polyamine such as ethylene diamine, propylene diamine, butylene diamine, and hexamethylene diamine; an alicyclic polyamine such as isophorone diamine and piperazine; and an aromatic polyamine.

The aromatic polyamine is not particularly limited, as long as it has at least two amino groups directly or indirectly bonded to an aromatic ring. Herein, the “indirectly bonded” means that the amino group is bonded to the aromatic ring via, for example, a lower alkylene bond.

The aromatic polyamine may be, for example, a monocyclic aromatic polyamine having at least two amino groups bonded to one aromatic ring, or a polycyclic aromatic polyamine having at least two aminophenyl groups each having at least one amino group bonded to one aromatic ring.

Examples of the monocyclic aromatic polyamine include a type having the amino groups directly bonded to the aromatic ring, such as phenylene diamine, toluene diamine, diethyltoluene diamine, and dimethylthiotoluene diamine; and a type having the amino groups bonded to the aromatic ring via the lower alkylene group, such as xylylene diamine.

In addition, the polycyclic aromatic polyamine may be a poly (aminobenzene) having at least two aminophenyl groups directly bonded to each other, or a compound having at least two aminophenyl groups bonded to each other via a lower alkylene group or an alkylene oxide group. Among them, a diaminodiphenyl alkane having two aminophenyl groups bonded to each other via a lower alkylene group is preferable. Particularly, 4,4′-diaminodiphenyl methane or the derivative thereof is preferable.

The molecular weight of the chain extender is preferably 400 or less, more preferably 350 or less, and even more preferably less than 200, and is preferably 30 or more, more preferably 40 or more, and even more preferably 45 or more. If the molecular weight is excessively great, it is difficult to distinguish the chain extender from the polyol constituting the soft segment of the polyurethane.

It is noted that the “low molecular weight polyol” and “low molecular weight polyamine” used as the chain extender are low molecular compounds which do not have a molecular weight distribution, and are distinguished from the polymer polyol having the number average molecular weight of 200 or more and 3000 or less obtained by polymerizing the low molecular compound.

The constitutional embodiment of the polyurethane is not particularly limited, and examples thereof include an embodiment where the polyurethane is composed of the polyisocyanate, and the polyol having the number average molecular weight of 200 or more and 6000 or less; an embodiment where the polyurethane is composed of the polyisocyanate, the polyol having the number average molecular weight of 200 or more and 6000 or less, and the chain extender; and an embodiment where the polyurethane is composed of the polyisocyanate, the first polymer polyol having the number average molecular weight of 200 or more and 3000 or less, the second polymer polyol having the number average molecular weight that is 1000 or more and 6000 or less and greater than the number average molecular weight of the first polymer polyol, and the chain extender component.

The polyurethane may be either a thermoplastic polyurethane or a thermosetting polyurethane. The thermoplastic polyurethane is a polyurethane exhibiting plasticity by heating and generally means a polyurethane having a linear chain structure of a high-molecular weight to a certain extent. The thermosetting polyurethane is a polyurethane obtained through a curing reaction between a prepolymer having a relatively low molecular weight and a curing agent. A three-dimensional crosslinked structure is formed in the thermosetting polyurethane by controlling the number of the functional group of the prepolymer or curing agent to be used. The polyurethane is preferably the thermoplastic polyurethane. If the polyurethane is the thermoplastic polyurethane, the cover is easily molded.

Examples of the synthesis method of the polyurethane include a one-shot method and a prepolymer method. The one-shot method is a method of reacting a polyisocyanate, a polyol, or the like at once. The prepolymer method is a method of reacting a polyisocyanate, a polyol, or the like in multiple steps, for example, a method of synthesizing a urethane prepolymer having a relatively low molecular weight followed by polymerizing the urethane prepolymer.

Next, as an example of producing the polyurethane by the prepolymer method, an embodiment in which an isocyanate group terminated urethane prepolymer is synthesized and then the isocyanate group terminated urethane prepolymer is polymerized using the chain extender will be described in detail.

First, a reaction between the polyisocyanate and the polymer polyol is carried out to synthesize the isocyanate group terminated urethane prepolymer. In this case, the charging ratio of the polyisocyanate to the polymer polyol is preferably 1 or more, more preferably 1.2 or more, and even more preferably 1.5 or more, and is preferably 10 or less, more preferably 9 or less, and even more preferably 8 or less in a molar ratio (NCO/OH) of the isocyanate group (NCO) included in the polyisocyanate to the hydroxy group (OH) included in the polymer polyol.

The temperature at which the prepolymer reaction is performed is preferably 10° C. or more, more preferably 30° C. or more, and even more preferably 50° C. or more, and is preferably 200° C. or less, more preferably 150° C. or less, and even more preferably 100° C. or less.

In addition, the reaction time is preferably 10 minutes or more, more preferably 1 hour or more, and even more preferably 3 hours or more, and is preferably 32 hours or less, more preferably 16 hours or less, and even more preferably 8 hours or less.

Next, the obtained isocyanate group terminated urethane prepolymer is subjected to a chain extension reaction with the chain extender to obtain the high molecular weight polyurethane. In this case, the charging ratio of the isocyanate group terminated urethane prepolymer to the chain extender is preferably 0.9 or more, more preferably 0.92 or more, and even more preferably 0.95 or more, and is preferably 1.1 or less, more preferably 1.08 or less, and even more preferably 1.05 or less in a molar ratio (NCO/OH) of the isocyanate group (NCO) included in the isocyanate group terminated urethane prepolymer to the hydroxy group (OH) of the chain extender.

The temperature at which the chain extension reaction is performed is preferably 10° C. or more, more preferably 30° C. or more, and even more preferably 50° C. or more, and is preferably 220° C. or less, more preferably 170° C. or less, and even more preferably 120° C. or less.

In addition, the reaction time is preferably 10 minutes or more, more preferably 30 minutes or more, and even more preferably 1 hour or more, and is preferably 20 days or less, more preferably 10 days or less, and even more preferably 5 days or less.

Each of the prepolymer reaction and the chain extension reaction is preferably conducted in an atmosphere of dry nitrogen.

A conventionally known catalyst can be used for the synthesis of the polyurethane. Examples of the catalyst include a monoamine such as triethyl amine and N,N-dimethylcyclohexylamine; a polyamine such as N,N,N′,N′-tetramethylethylene diamine and N,N,N′, N″, N″-pentamethyldiethylene triamine; a cyclic diamine such as 1,8-diazabicyclo [5.4.0]-7-undecene (DBU) and triethylene diamine; a tin catalyst such as dibutyl tin dilaurate and dibutyl tin diacetate. These catalysts may be used solely, or two or more of the catalysts may be used in combination. Among them, the tin catalyst such as dibutyl tin dilaurate and dibutyl tin diacetate is preferred, and in particular, dibutyl tin dilaurate is preferably used.

The amount of the polyurethane is preferably 50 mass % or more, more preferably 70 mass % or more, and even more preferably 90 mass % or more in 100 mass % of the resin component of the golf ball cover material. The resin component may consist of the polyurethane.

The golf ball cover material may contain one polyurethane as the resin component, or may contain two or more polyurethanes as the resin component. The golf ball cover material preferably contains the first polyurethane containing the first polymer polyol as the constituent component and the second polyurethane containing the second polymer polyol as the constituent component.

When the golf ball cover material contains the first polyurethane and the second polyurethane as the resin component, their mass ratio (first polyurethane/second polyurethane) is preferably 1/99 or more, more preferably 30/70 or more, and even more preferably 50/50 or more, and is preferably 99/1 or less, more preferably 98/2 or less, and even more preferably 95/5 or less.

The golf ball cover material preferably contains only the polyurethane as the resin composition, but may further contain another resin component, as long as another resin component doesn't impair the effect of the present disclosure.

Examples of another resin component include an ionomer resin and a thermoplastic elastomer.

Examples of the ionomer resin include a product obtained by neutralizing at least a part of carboxyl groups in a copolymer composed of ethylene and an α,β-unsaturated carboxylic acid having 3 to 8 carbon atoms with a metal ion; a product obtained by neutralizing at least a part of carboxyl groups in a terpolymer composed of ethylene, an α,β-unsaturated carboxylic acid having 3 to 8 carbon atoms and an α,β-unsaturated carboxylic acid ester with a metal ion; and a mixture of those. Specific examples of the ionomer resin include “Himilan (registered trademark)” available from Dow-Mitsui Polychemicals Co., Ltd., “Surlyn (registered trademark)” available from E.I. du Pont de Nemours and Company, and “lotek (registered trademark)” available from ExxonMobil Chemical Corporation.

Specific examples of the thermoplastic elastomer include a thermoplastic polyurethane elastomer such as “Elastollan (registered trademark) (e.g. “Elastollan XNY88A”)” available from BASF Japan Ltd.; a thermoplastic polyamide elastomer such as “Pebax (registered trademark) (e.g. “Pebax 2533”)” available from Arkema Inc.; a thermoplastic polyester elastomer such as “Hytrel (registered trademark) (e.g. “Hytrel 3548”, “Hytrel 4047”)” available from Du Pont-Toray Co., Ltd.; and a thermoplastic polystyrene elastomer such as “Rabalon (registered trademark)” available from Mitsubishi Chemical Corporation.

The golf ball cover material may further contain a pigment component such as titanium oxide and a blue pigment, a weight adjusting agent such as calcium carbonate and barium sulfate, a dispersant, an antioxidant, an ultraviolet absorber, a light stabilizer, a fluorescent material or fluorescent brightener, as long as they do not impair the performance of the cover.

The amount of the white pigment (e.g. titanium oxide) is preferably 0.5 part by mass or more, more preferably 1 part by mass or more, and even more preferably 1.5 parts by mass or more, and is preferably 10 parts by mass or less, more preferably 8 parts by mass or less, and even more preferably 6 parts by mass or less, with respect to 100 parts by mass of the resin component. If the amount of the white pigment is 0.5 part by mass or more, it is possible to impart the opacity to the golf ball material, and if the amount of the white pigment is 10 parts by mass or less, lowering in the durability of the golf ball material can be suppressed.

### [Golf Ball]

The golf ball according to the present disclosure comprises a spherical core and a cover covering the spherical core, wherein the cover is formed from the above golf ball cover material.

### (Spherical Core)

Examples of the spherical core include a single-layered spherical core; a spherical core composed of a center and one intermediate layer covering the center; and a spherical core composed of a center and two or more intermediate layers covering the center.

A conventionally known rubber composition (hereinafter sometimes simply referred to as “core rubber composition”) may be used for the spherical core or center, and the spherical core or center may be formed by heat pressing, for example, a rubber composition containing a base rubber, a co-crosslinking agent and a crosslinking initiator.

As the base rubber, particularly preferred is a high cis-polybutadiene having a cis-bond in an amount of 40 mass % or more, preferably 70 mass % or more, and more preferably 90 mass % or more in view of its advantageous resilience.

As the co-crosslinking agent, an α,β-unsaturated carboxylic acid having 3 to 8 carbon atoms or a metal salt thereof is preferable, and acrylic acid or a metal salt thereof, methacrylic acid or a metal salt thereof is more preferable. As the metal constituting the metal salt, zinc, magnesium, calcium, aluminum or sodium is preferable, and zinc is more preferable. The amount of the co-crosslinking agent is preferably 20 parts by mass or more and 50 parts by mass or less with respect to 100 parts by mass of the base rubber. When the α,β-unsaturated carboxylic acid having 3 to 8 carbon atoms is used as the co-crosslinking agent, a metal compound (e.g. magnesium oxide) is preferably used in combination.

As the crosslinking initiator, an organic peroxide is preferably used. Specific examples of the organic peroxide include dicumyl peroxide, 1,1-bis(t-butylperoxy)-3,3,5-trimethylcyclohexane, 2,5-dimethyl-2,5-di(t-butylperoxy) hexane, and di-t-butyl peroxide. Among them, dicumyl peroxide is preferably used. The amount of the crosslinking initiator is preferably 0.2 part by mass or more, more preferably 0.3 part by mass or more, and even more preferably 0.4 part by mass or more, and is preferably 5 parts by mass or less, more preferably 4 parts by mass or less, and even more preferably 3 parts by mass or less, with respect to 100 parts by mass of the base rubber.

In addition, the core rubber composition may further contain an organic sulfur compound. As the organic sulfur compound, diphenyl disulfides, thiophenols or thionaphthols are preferably used. The amount of the organic sulfur compound is preferably 0.1 part by mass or more, more preferably 0.3 part by mass or more, and even more preferably 0.5 part by mass or more, and is preferably 5.0 parts by mass or less, more preferably 4.0 parts by mass or less, and even more preferably 2.0 parts by mass or less, with respect to 100 parts by mass of the base rubber.

The core rubber composition may further contain a carboxylic acid and/or a salt thereof. As the carboxylic acid and/or the salt thereof, a carboxylic acid having 1 to 30 carbon atoms and/or a salt thereof is preferred. As the carboxylic acid, an aliphatic carboxylic acid or an aromatic carboxylic acid (e.g. benzoic acid) may be used. The amount of the carboxylic acid and/or the salt thereof is preferably 1 part by mass or more and 40 parts by mass or less with respect to 100 parts by mass of the base rubber.

The core rubber composition may further contain a weight adjusting agent such as zinc oxide and barium sulfate, an antioxidant, or a colored powder, in addition to the base rubber, the co-crosslinking agent, the crosslinking initiator, and the organic sulfur compound.

The molding conditions for heat pressing the core rubber composition may be determined appropriately depending on the rubber formulation. Generally, the heat pressing is preferably carried out at a temperature of 130° C. to 200° C. for 10 to 60 minutes, or carried out in a two-step heating of heating at a temperature of 130° C. to 150° C. for 20 to 40 minutes followed by heating at a temperature of 160° C. to 180° C. for 5 to 15 minutes.

When the spherical core comprises an intermediate layer, examples of the intermediate layer material include a thermoplastic resin such as a polyurethane resin, an ionomer resin, a polyamide resin, and polyethylene; a thermoplastic elastomer such as a styrene elastomer, a polyolefin elastomer, a polyurethane elastomer, a polyamide elastomer, and a polyester elastomer; and a cured product of a rubber composition. Herein, examples of the ionomer resin include a product obtained by neutralizing at least a part of carboxyl groups in a copolymer composed of ethylene and an α,β-unsaturated carboxylic acid with a metal ion; and a product obtained by neutralizing at least a part of carboxyl groups in a terpolymer composed of ethylene, an α,β-unsaturated carboxylic acid and an α,β-unsaturated carboxylic acid ester with a metal ion. The intermediate layer may further contain a weight adjusting agent such as barium sulfate and tungsten, an antioxidant, and a pigment.

The method for molding the intermediate layer is not particularly limited, and examples thereof include a method which comprises molding the intermediate layer composition into a half shell in advance, covering the spherical body with two of the half shells, and performing compression molding; and a method which comprises injection molding the intermediate layer composition directly onto the spherical body to cover the spherical body.

In case of injection molding the intermediate layer composition onto the spherical body to form the intermediate layer, it is preferred to use upper and lower molds, each having a hemispherical cavity. When molding the intermediate layer by the injection molding method, the hold pin is protruded to hold the spherical body to be covered, and the intermediate layer composition which has been heated and melted is charged and then cooled to form the intermediate layer.

When molding the intermediate layer by the compression molding method, the molding of the half shell may be performed by either a compression molding method or an injection molding method, and the compression molding method is preferable. Compression molding the intermediate layer composition into the half shell may be carried out, for example, under a pressure of 1 MPa or more and 20 MPa or less at a molding temperature of −20° C. or more and +70° C. or less relative to the flow beginning temperature of the intermediate layer composition. If the molding is carried out under the above conditions, the half shell having a uniform thickness can be formed. Examples of the method for molding the intermediate layer by using the half shell include a method which comprises covering the spherical body with two of the half shells and performing compression molding. Compression molding the half shells into the intermediate layer may be carried out, for example, under a pressure of 0.5 MPa or more and 25 MPa or less at a molding temperature of −20° C. or more and +70° C. or less relative to the flow beginning temperature of the intermediate layer composition. If the molding is carried out under the above conditions, the intermediate layer having a uniform thickness can be formed.

It is noted that the molding temperature means the highest temperature where the temperature at the surface of the concave portion of the lower mold reaches from closing the mold to opening the mold. In addition, the flow beginning temperature of the composition can be measured using the thermoplastic resin composition in a pellet form under the following conditions with “Flow Tester CFT-500” available from Shimadzu Corporation.
Measuring conditions: Plunger area: 1 cm², Die length: 1 mm, Die diameter: 1 mm, Load: 588.399 N, Starting temperature: 30° C., and Temperature rising rate: 3° C./min.

The center hardness Ho of the spherical core is preferably 40 or more, more preferably 45 or more, and even more preferably 50 or more in Shore C hardness. If the center hardness Ho of the spherical core is 40 or more in Shore C hardness, the spherical core is not excessively soft and thus has better resilience. In addition, the center hardness Ho of the spherical core is preferably 75 or less, more preferably 70 or less, and even more preferably 65 or less in Shore C hardness. If the center hardness Ho of the spherical core is 75 or less in Shore C hardness, the spherical core is not excessively hard and thus has better shot feeling.

The surface hardness Hs of the spherical core is preferably 65 or more, more preferably 70 or more, and even more preferably 75 or more, and is preferably 100 or less, more preferably 95 or less, and even more preferably 90 or less in Shore C hardness. If the surface hardness of the spherical core is 65 or more in Shore C hardness, the spherical core is not excessively soft and thus has better resilience. In addition, if the surface hardness of the spherical core is 100 or less in Shore C hardness, the spherical core is not excessively hard and thus has better shot feeling.

The hardness difference (Hs−Ho) between the surface hardness Hs and the center hardness Ho of the spherical core is preferably 10 or more, more preferably 12 or more, and even more preferably 15 or more, and is preferably 40 or less, more preferably 35 or less, and even more preferably 30 or less in Shore C hardness. If the hardness difference between the core surface and the core center is great, the obtained golf ball shows a high launch angle and a low spin rate, and travels a great flight distance.

The diameter of the spherical core is preferably 34.8 mm or more, more preferably 36.8 mm or more, and even more preferably 38.8 mm or more, and is preferably 42.2 mm or less, more preferably 41.8 mm or less, even more preferably 41.2 mm or less, and most preferably 40.8 mm or less. If the diameter of the spherical core is 34.8 mm or more, the cover is not excessively thick and thus the resilience is better. On the other hand, if the diameter of the spherical core is 42.2 mm or less, the cover is not excessively thin and thus the cover functions better.

When the spherical core has a diameter in the range from 34.8 mm to 42.2 mm, the compression deformation amount of the spherical core (shrinking amount of the spherical core along the compression direction) when applying a load from an initial load of 98 N to a final load of 1275 N to the spherical core is preferably 2.0 mm or more, more preferably 2.4 mm or more, and even more preferably 2.8 mm or more, and is preferably 6.0 mm or less, more preferably 5.0 mm or less, and even more preferably 4.5 mm or less. If the compression deformation amount is 2.0 mm or more, the shot feeling is better, and if the compression deformation amount is 6.0 mm or less, the resilience is better.

### (Construction of Golf Ball)

The construction of the golf ball is not particularly limited, as long as the golf ball comprises a spherical core and a cover covering the spherical core. Examples of the construction of the golf ball include a two-piece golf ball having a single-layered spherical core and a cover covering the spherical core; a three-piece golf ball having a spherical core composed of a center and one intermediate layer covering the center, and a cover covering the spherical core; and a multi-piece golf ball having a spherical core composed of a center and two of more intermediate layers covering the center, and a cover covering the spherical core.

The method for forming the cover from the cover material is not particularly limited, and examples thereof include a method which comprises injection molding the cover material directly onto the spherical core; and a method which comprises molding the cover material into a hollow shell, covering the spherical core with a plurality of the shells and performing compression molding (preferably a method which comprises molding the cover material into a hollow half-shell, covering the spherical core with two of the half-shells and performing compression molding). The golf ball body having the cover formed thereon is ejected from the mold, and is preferably subjected to surface treatments such as deburring, cleaning and sandblast where necessary. In addition, if desired, a paint film or a mark may be formed.

The thickness of the cover is preferably 0.3 mm or more, more preferably 0.4 mm or more, and even more preferably 0.5 mm or more, and is preferably 2.0 mm or less, more preferably 1.5 mm or less, and even more preferably 1.0 mm or less. If the thickness of the cover is 0.3 mm or more, the cover is more easily molded, and if the thickness of the cover is 2.0 mm or less, the core has a relatively large diameter and thus the golf ball has enhanced resilience performance.

The total number of the dimples formed on the cover is preferably 200 or more and 500 or less. If the total number of the dimples is less than 200, the dimple effect is hardly obtained. In addition, if the total number of the dimples exceeds 500, the dimple effect is hardly obtained because the size of the respective dimples is small. The shape (shape in a plan view) of the formed dimples includes, without limitation, a circle; a polygonal shape such as a roughly triangular shape, a roughly quadrangular shape, a roughly pentagonal shape and a roughly hexagonal shape; and other irregular shapes. These shapes may be employed solely, or at least two of them may be employed in combination.

The golf ball body having the cover formed thereon is ejected from the mold, and is preferably subjected to surface treatments such as deburring, cleaning and sandblast where necessary. In addition, if desired, a paint film or a mark may be formed. The thickness of the paint film is not particularly limited, and is preferably 5 μm or more, more preferably 7 μm or more, and even more preferably 9 μm or more, and is preferably 50 μm or less, more preferably 40 μm or less, and even more preferably 30 μm or less. If the thickness of the paint film is 5 μm or more, the paint film is hard to wear off even if the golf ball is used continuously, and if the thickness of the paint film is 50 μm or less, the dimple effect is fully obtained.

The golf ball preferably has a diameter ranging from 40 mm to 45 mm. In light of satisfying the regulation of US Golf Association (USGA), the diameter is particularly preferably 42.67 mm or more. In light of prevention of air resistance, the diameter is more preferably 44 mm or less, and particularly preferably 42.80 mm or less. In addition, the golf ball according to the present disclosure preferably has a mass of 40 g or more and 50 g or less. In light of obtaining greater inertia, the mass is more preferably 44.00 g or more, and particularly preferably 45.00 g or more. In light of satisfying the regulation of USGA, the mass is particularly preferably 45.93 g or less.

When the golf ball according to the present disclosure has a diameter in the range of from 40 mm to 45 mm, the compression deformation amount (shrinking amount along the compression direction) of the golf ball when applying a load from an initial load of 98 N to a final load of 1275 N to the golf ball is preferably 2.0 mm or more, more preferably 2.4 mm or more, and even more preferably 2.5 mm or more, and is preferably 5.0 mm or less, more preferably 4.5 mm or less, and even more preferably 4.0 mm or less. If the compression deformation amount is 2.0 mm or more, the golf ball is not excessively hard and thus has better shot feeling. On the other hand, if the compression deformation amount is 5.0 mm or less, the resilience is higher.

The FIGURE is a partially cutaway cross-sectional view showing a golf ball 1 according to one embodiment of the present disclosure. The golf ball 1 comprises a spherical core 2, and a cover 3 positioned outside the spherical core 2. A plurality of dimples 31 are formed on the surface of the cover 3. Other portions than the dimples 31 on the surface of the cover 3 are lands 32. The cover 3 is formed from the above cover material.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### [Evaluation Method]

### (1) Number Average Molecular Weight of Polyol Components

Gel permeation chromatography was conducted to determine the number average molecular weight of the polyol component under the following conditions.
<Measuring conditions>
Apparatus: HLC-8120GPC available from Tosoh Corporation
Eluent: tetrahydrofuran (THF)
Temperature: 40° C.
Column: TSK gel Super HM-M (available from Tosoh Corporation)
Polyol concentration: 0.2 mass % (polyol/(polyol+THF))
Sample injection volume: 5 μl
Flow rate: 0.5 ml/min
Molecular weight standard: polystyrene (PSt Quick Kit-H available from Tosoh Corporation)

### (2) Slab Hardness of Golf Ball Cover Material (Shore a Hardness)

Sheets with a thickness of about 2 mm were produced by injection molding the golf ball cover material. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore A”.

### (3) Slab Hardness of Intermediate Layer (Shore D Hardness)

Sheets with a thickness of about 2 mm were produced by injection molding the resin composition. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore D”.

### (4) Loss Elastic Modulus E″ (Pa)

The loss elastic modulus E″ (Pa) of the cover material was measured under the following conditions.

Apparatus: dynamic viscoelasticity measuring apparatus “Rheogel-E4000” available from UBM corporation

Measured sample: a sheet having a thickness of 0.5 mm was produced by press molding the cover material, and a test piece having a width of 4 mm and a length between clamps of 20 mm was cut from the sheet.
<Measuring conditions>
Measuring mode: tensile mode
Measuring temperature: −100° C. to 100° C.
Temperature rising rate: 4° C./minute
Oscillation frequency: 10 Hz
Measuring strain: 0.05%.

### (5) Spin Rate on Driver Shots

A driver provided with a titanium head (SRIXON (registered trademark) ZX7, loft angle: 10.5°, hardness: S, available from Sumitomo Rubber Industries, Ltd.) was installed on a swing robot M/C available from True Temper Sports, Inc. The golf ball was hit at a head speed of 50 m/sec, and the spin rate of the golf ball right after being hit was measured. The measurement was conducted ten times for each golf ball, and the average value thereof was adopted as the measurement value for that golf ball. It is noted that the spin rate of the golf ball right after being hit was measured by continuously taking a sequence of photographs of the hit golf ball.

### (6) Spin Rate on 8-Iron Shots

An 8-iron provided with a titanium head (SRIXON (registered trademark) ZX7, loft angle: 36°, hardness: S, available from Sumitomo Rubber Industries, Ltd.) was installed on a swing robot M/C available from True Temper Sports, Inc. The golf ball was hit at a head speed of 39 m/sec, and the spin rate of the golf ball right after being hit was measured. The measurement was conducted ten times for each golf ball, and the average value thereof was adopted as the measurement value for that golf ball. It is noted that the spin rate of the golf ball right after being hit was measured by continuously taking a sequence of photographs of the hit golf ball.

### [Synthesis of Polyurethane]

Polyurethanes having the compositions shown in Table 1 were synthesized as follows.

Polytetramethylene ether glycol (PTMG) heated to a temperature of 80° C. was added to dicyclohexylmethane diisocyanate (H₁₂MDI) heated to a temperature of 80° C. Further, dibutyl tin dilaurate (dibutyl tin dilaurate available from Aldrich, Inc.) was added thereto in an amount of 0.005 mass % of the total amount of the raw materials (H₁₂MDI, PTMG, and BD), and then the mixture was stirred at a temperature of 80° C. for 2 hours under a nitrogen gas flow. Subsequently, butane diol (BD) heated to a temperature of 80° C. was added thereto under a nitrogen gas flow, and then the mixture was stirred at a temperature of 80° C. for 1 minute. Next, the reaction liquid was cooled, and degassed under reduced pressure for 1 minute at room temperature. The degassed reaction liquid was spread in a container, and stored at a temperature of 110° C. for 6 hours under a nitrogen gas atmosphere to conduct a urethane-forming reaction, thereby obtaining the polyurethanes.

TABLE 1

| Polyurethane No. | | | A | B | C | D | E |
|---|---|---|---|---|---|---|---|
| Composition | Polyol | PTMG650 | 1.00 | — | — | — | — |
| (molar ratio) | | PTMG1000 | — | 1.00 | — | — | — |
| | | PTMG1400 | — | — | 1.00 | — | — |
| | | PTMG2000 | — | — | — | 1.00 | — |
| | | PTMG3000 | — | — | — | — | 1.00 |
| | Polyisocyanate | H₁₂MDI | 2.21 | 3.07 | 3.81 | 4.50 | 4.36 |
| | Chain extender | BD | 1.21 | 2.07 | 2.81 | 3.50 | 3.36 |

PTMG 650: polytetramethylene ether glycol (number average molecular weight: 650)
PTMG 1000: polytetramethylene ether glycol (number average molecular weight: 1000)
PTMG 1400: polytetramethylene ether glycol (number average molecular weight: 1400)
PTMG 2000: polytetramethylene ether glycol (number average molecular weight: 2000)
PTMG 3000: polytetramethylene ether glycol (number average molecular weight: 3000)
H₁₂MDI: dicyclohexyl methane diisocyanate
BD: 1,4-butane diol

### [Production of Golf Ball] (1)

### Production of Intermediate Layer Covering Spherical Body

According to the formulation shown in Table 2, the core rubber composition was kneaded, and heat-pressed in upper and lower molds, each having a hemispherical cavity, at a temperature of 170° C. for 15 minutes to obtain the spherical core having a diameter of 38.5 mm.

Then, according to the formulation shown in Table 3, the intermediate materials were extruded with a twin-screw kneading extruder to prepare the intermediate layer composition in a pellet form. The extruding conditions were a screw diameter of 45 mm, a screw rotational speed of 200 rpm, and a screw L/D=35, and the mixture was heated to a temperature ranging from 150° C. to 230° C. at the die position of the extruder. The obtained intermediate layer composition was injection molded onto the core obtained above to cover the core such that the intermediate layer had a thickness of 1.6 mm and the intermediate layer covering spherical body had a diameter of 41.7 mm.

TABLE 2
Core

| | | |
|---|---|---|
| Formulation of core | Polybutadiene rubber | 100 |
| rubber composition | Zinc diacrylate | 38 |
| (parts by mass) | Zinc oxide | 5 |
| | Diphenyl disulfide | 0.5 |
| | Dicumyl peroxide | 1 |

| | |
|---|---|
| Diameter (mm) | 38.5 |

Polybutadiene rubber: “BR730 (high-cis polybutadiene)” available from JSR Corporation
Zinc diacrylate: “ZN-DA90S” available from Nisshoku Techno Fine Chemical Co., Ltd.
Zinc oxide: “Ginrei R” available from Toho Zinc Co., Ltd.
Diphenyl disulfide: available from Sumitomo Seika Chemicals Co., Ltd.
Dicumyl peroxide: “Percumyl (registered trademark) D” available from NOF Corporation

TABLE 3
Intermediate layer

| | | | |
|---|---|---|---|
| Intermediate | Formulation | Himilan 1605 | 50 |
| layer composition | (parts by mass) | Himilan AM7329 | 50 |

| | |
|---|---|
| Slab hardness (Shore D) | 64 |

| | |
|---|---|
| Thickness (mm) | 1.6 |

Himilan (registered trademark) 1605: sodium ion neutralized ethylene-methacrylic acid copolymer ionomer resin available from Dow-Mitsui Polychemicals Co., Ltd.
Himilan AM7329: zinc ion neutralized ethylene-methacrylic acid copolymer ionomer resin available from Dow-Mitsui Polychemicals Co., Ltd.

### (2) Molding of Half Shell

According to the formulations shown in Table 4, the polyurethane and titanium dioxide were dry blended, and mixed with a twin-screw kneading extruder to obtain cover materials in a pellet form. The extruding conditions were a screw diameter of 45 mm, a screw rotational speed of 200 rpm, and a screw L/D=35, and the mixture was heated to a temperature ranging from 150° C. to 230° C. at the die position of the extruder. The compression molding of the half shells was conducted by charging the obtained cover material in the pellet form into the depressed part of the lower mold for molding half shells one by one, and applying pressure to mold half shells. The compression molding was conducted under the conditions of a molding temperature of 170° C., a molding time of 5 minutes and a molding pressure of 2.94 MPa.

### (3) Molding of Cover

The intermediate layer covering spherical body obtained in (1) was concentrically covered with two of the half shells obtained in (2), and compression molding was conducted to mold the cover. The compression molding was conducted under the conditions of a molding temperature of 145° C., a molding time of 2 minutes and a molding pressure of 9.8 MPa.

The surface of the obtained golf ball body was subjected to a sandblast treatment, and a mark was formed thereon. Then, a clear paint was applied thereon, and dried in an oven of 40° C. to obtain golf balls having a diameter of 42.7 mm and a mass of 45.3 g. The evaluation results regarding the spin performance of the obtained golf balls are shown in Table 4.

TABLE 4

| Golf ball No. | | | 1 | 2 | 3 | 4 | 5 | 6 | 7 |
|---|---|---|---|---|---|---|---|---|---|
| Cover | Formulation | Polyurethane A | 100 | — | — | — | — | — | — |
| material | (parts by mass) | Polyurethane B | — | 100 | — | — | — | — | — |
| | | Polyurethane C | — | — | 95 | 90 | 80 | 50 | — |
| | | Polyurethane D | — | — | 5 | 10 | 20 | 50 | — |
| | | Polyurethane E | — | — | — | — | — | — | 100 |
| | | Titanium dioxide | 4 | 4 | 4 | 4 | 4 | 4 | 4 |

| | | | | | | | |
|---|---|---|---|---|---|---|---|
| Slab hardness (Shore A) | 82 | 82 | 82 | 82 | 82 | 82 | 82 |
| Loss elastic modulus (E″₋₄₀) (×10⁷ Pa) | 11.0 | 15.8 | 9.27 | 8.73 | 8.22 | 6.87 | 3.33 |
| Loss elastic modulus (E″₋₂₀) (×10⁷ Pa) | 10.9 | 11.6 | 4.16 | 4.51 | 4.89 | 6.24 | 3.43 |

| Cover thickness (mm) | | 0.5 | 0.5 | 0.5 | 0.5 | 0.5 | 0.5 | 0.5 |
|---|---|---|---|---|---|---|---|---|
| Spin rate (rpm) | Driver shots | 2285 | 2380 | 2400 | 2410 | 2420 | 2450 | 2750 |
| | Iron shots | 5745 | 6135 | 6700 | 6735 | 6770 | 6875 | 7500 |

The golf balls No. 3 to 6 are the cases that the cover is formed from a golf ball cover material having a loss elastic modulus (E″₋₄₀) in a range from 6.50×10⁷ Pa to 22.0×10⁷ Pa and a loss elastic modulus (E″₋₂₀) in a range from 3.50×10⁷ Pa to 7.10×10⁷ Pa.

These golf balls No. 3 to 6 showed a decreased spin rate on driver shots and an increased spin rate on iron shots.

The golf balls No. 1 and 2 are the cases that the cover is formed from a golf ball cover material having a loss elastic modulus (E″₋₄₀) in a range from 6.50×10⁷ Pa to 22.0×10⁷ Pa and a loss elastic modulus (E″₋₂₀) of more than 7.10×10⁷ Pa.

These golf balls No. 1 and 2 showed a decreased spin rate on driver shots and a decreased spin rate on iron shots.

The golf ball No. 7 is the case that the cover is formed from a golf ball cover material having a loss elastic modulus (E″₋₂₀) in a range from 3.50×10⁷ Pa to 7.10×10⁷ Pa and a loss elastic modulus (E″₋₄₀) of less than 6.50×10⁷ Pa.

The golf ball No. 7 showed an increased spin rate on driver shots and an increased spin rate on iron shots.

The present disclosure (1) is a golf ball cover material having a loss elastic modulus (E″₋₄₀) in a range from 6.50×10⁷ Pa to 22.0×10⁷ Pa at a measuring temperature of −40° C., and a loss elastic modulus (E″₋₂₀) in a range from 3.50×10⁷ Pa to 7.10×10⁷ Pa at a measuring temperature of −20° C., when measured using a dynamic viscoelasticity measuring apparatus under following measuring conditions:
<Measuring conditions>
Measuring mode: tensile mode
Measuring temperature: −100° C. to 100° C.
Temperature rising rate: 4° C./minute
Oscillation frequency: 10 Hz
Measuring strain: 0.05%.

The present disclosure (2) is the golf ball cover material according to the present disclosure (1), wherein the golf ball cover material contains, as a resin component, a polyurethane obtained by a reaction between a polyol and a polyisocyanate.

The present disclosure (3) is the golf ball cover material according to the present disclosure (2), wherein the polyol constituting the polyurethane contains at least one polymer polyol selected from the group consisting of a polyether polyol, a condensed polyester polyol, a lactone polyester polyol, a polycarbonate polyol, and an acrylic polyol.

The present disclosure (4) is the golf ball cover material according to the present disclosure (2) or (3), wherein the polyol constituting the polyurethane contains a first polymer polyol and a second polymer polyol having a number average molecular weight greater than the first polymer polyol.

The present disclosure (5) is the golf ball cover material according to any one of the present disclosures (2) to (4), wherein an amount of the polyether polyol is 50 mass % or more in 100 mass % of the polyol constituting the polyurethane.

The present disclosure (6) is a golf ball comprising a spherical core and a cover covering the spherical core, wherein the cover is formed from the golf ball cover material according to any one of the present disclosures (1) to (5).

This application is based on Japanese patent application No. 2023-192231 filed on Nov. 10, 2023, the content of which is hereby incorporated by reference.

1. A golf ball cover material having a loss elastic modulus (E″₋₄₀) in a range from 6.50×10⁷ Pa to 22.0×10⁷ Pa at a measuring temperature of −40° C., and a loss elastic modulus (E″₋₂₀) in a range from 3.50×10⁷ Pa to 7.10×10⁷ Pa at a measuring temperature of −20° C., when measured using a dynamic viscoelasticity measuring apparatus under following measuring conditions:
<Measuring Conditions>
Measuring mode: tensile mode
Measuring temperature: −100° C. to 100° C.
Temperature rising rate: 4° C./minute
Oscillation frequency: 10 Hz
Measuring strain: 0.05%.

2. The golf ball cover material according to claim 1, wherein the golf ball cover material contains, as a resin component, a polyurethane obtained by a reaction between a polyol and a polyisocyanate.

3. The golf ball cover material according to claim 2, wherein the polyol constituting the polyurethane contains at least one polymer polyol selected from the group consisting of a polyether polyol, a condensed polyester polyol, a lactone polyester polyol, a polycarbonate polyol, and an acrylic polyol.

4. The golf ball cover material according to claim 3, wherein the polyol constituting the polyurethane contains a first polymer polyol and a second polymer polyol having a number average molecular weight greater than the first polymer polyol.

5. The golf ball cover material according to claim 2, wherein an amount of a polyether polyol is 50 mass % or more in 100 mass % of the polyol constituting the polyurethane.

6. The golf ball cover material according to claim 1, wherein the golf ball cover material has a slab hardness ranging from 65 to 95 in Shore A hardness.

7. The golf ball cover material according to claim 4, wherein the first polymer polyol has a number average molecular weight (Mm1) ranging from 200 to 3000, and the second polymer polyol has a number average molecular weight (Mm2) ranging from 1000 to 6000.

8. The golf ball cover material according to claim 4, wherein a difference (Mm2-Mm1) between a number average molecular weight (Mm2) of the second polymer polyol and a number average molecular weight (Mm1) of the first polymer polyol ranges from 50 to 1500.

9. The golf ball cover material according to claim 4, wherein the golf ball cover material contains a first polyurethane containing the first polymer polyol as a constituent component and a second polyurethane containing the second polymer polyol as a constituent component.

10. A golf ball comprising a spherical core and a cover covering the spherical core, wherein the cover is formed from a golf ball cover material having a loss elastic modulus (E″₋₄₀) in a range from 6.50×10⁷ Pa to 22.0×10⁷ Pa at a measuring temperature of −40° C., and a loss elastic modulus (E″₋₂₀) in a range from 3.50×10⁷ Pa to 7.10×10⁷ Pa at a measuring temperature of −20° C., when measured using a dynamic viscoelasticity measuring apparatus under following measuring conditions:
<Measuring conditions>
Measuring mode: tensile mode
Measuring temperature: −100° C. to 100° C.
Temperature rising rate: 4° C./minute
Oscillation frequency: 10 Hz
Measuring strain: 0.05%.

11. The golf ball according to claim 10, wherein the golf ball cover material contains, as a resin component, a polyurethane obtained by a reaction between a polyol and a polyisocyanate.

12. The golf ball according to claim 11, wherein the polyol constituting the polyurethane contains at least one polymer polyol selected from the group consisting of a polyether polyol, a condensed polyester polyol, a lactone polyester polyol, a polycarbonate polyol, and an acrylic polyol.

13. The golf ball according to claim 12, wherein the polyol constituting the polyurethane contains a first polymer polyol and a second polymer polyol having a number average molecular weight greater than the first polymer polyol.

14. The golf ball according to claim 11, wherein an amount of a polyether polyol is 50 mass % or more in 100 mass % of the polyol constituting the polyurethane.

15. The golf ball according to claim 10, wherein the golf ball cover material has a slab hardness ranging from 65 to 95 in Shore A hardness.

16. The golf ball according to claim 13, wherein the first polymer polyol has a number average molecular weight (Mm1) ranging from 200 to 3000, and the second polymer polyol has a number average molecular weight (Mm2) ranging from 1000 to 6000.

17. The golf ball according to claim 13, wherein a difference (Mm2-Mm1) between a number average molecular weight (Mm2) of the second polymer polyol and a number average molecular weight (Mm1) of the first polymer polyol ranges from 50 to 1500.

18. The golf ball according to claim 13, wherein the golf ball cover material contains a first polyurethane containing the first polymer polyol as a constituent component and a second polyurethane containing the second polymer polyol as a constituent component.
